(19) United States
(12) Patent Application Publication
(10) Pub. No.: US 2024/0017788 A1
(43) Pub. Date: Jan. 18, 2024

(54) QUICK-RELEASE FOR BICYCLE

(71) Applicant: WEI-TING LIU, TAICHUNG CITY (TW)

(72) Inventor: WEI-TING LIU, TAICHUNG CITY (TW)

(21) Appl. No.: 18/054,275

(22) Filed: Nov. 10, 2022

(30) Foreign Application Priority Data
Jul. 14, 2022 (TW) 111126426

(51) Int. Cl. B62K 25/02; F16B 7/04

(52) U.S. Cl. CPC B62K 25/02; F16B 7/042; B62K 2206/00

(57) ABSTRACT

A quick-release includes axle having a head and an outer threaded end formed to two ends thereof. The axle is threadedly connected to the chain stay of a bicycle. The axle includes a passage defined axially therethrough. A groove is formed radially through the head, and two recesses are respectively formed in two insides of the groove. A knob is fitted in the groove of the head. A rod is movably located in the passage and has an engaging end which is connected to the knob. A ball is formed to the rod. A non-circular hole is formed in the ball. When the rod is pulled and the ball is rotatably engaged with the two recesses, the rod is pivoted and partially engaged with the groove so as to rotate the axle to esparto the wheels from the chain stay.

### BACKGROUND OF THE INVENTION

### 1. Fields of the Invention

The present invention relates to a quick-release, and more particularly, to a quick-release for bicycles, and the rod for the quick-lease is hidden in the rear wheel hub.

### 2. Descriptions of Related Art

There are some parts of bicycles require replacement or adjustment, such as the wheel hub relative to the axle, and the seat relative to the seat tube, the quick-release is used to achieve the purpose without using extra tools. The latest quick-release for bicycles includes an axle with a washer mounted thereto, and the axle extends through one of the two dropouts of the front fork so as to be threadedly connected to another one of the two dropouts. The washer is sandwiched between the head of the axle and the dropout.

A bicycle quick-release known to applicant is disclosed in Taiwanese Patent No. I728299, and includes a rod, an axle, an end cap, and a pin. The axle includes a passage defined axially therethrough. The end cap has a groove and a hole that extends radially through the groove which communicates with the passage. The rod includes a slot and the rod is located in the axle via the groove. The slot is located corresponding to the hole. The pin extends through the hole and pulls the rod from the axle. The rod contacts the periphery of the groove to rotate the axle to separate the wheel from the front fork.

That is to say, by using the quick-release, the wheel can be removed from the front fork without using any tool. However, the parts of the quick-release require complicated machining processes such as the slot of the rod and the groove of the end cap. A positioning mechanism is required to the rod and the head that is assembled to the rod. Therefore, the above mentioned quick-release is suffered by high manufacturing cost.

The present invention intends to provide a quick-release for bicycles to eliminate the shortcomings mentioned above.

### SUMMARY OF THE INVENTION

The present invention relates to a quick-release and comprises an axle threadedly connected to a bicycle, and the axle has a head formed to the first end thereof, and an outer threaded end is formed to the second end of the axle. A passage is defined axially through the axle. A groove is formed radially through the head. Two recesses are respectively formed in two insides of the groove and located corresponding to the passage. An operation unit includes a knob and a rod, wherein the knob includes a first side and a second side. The first side of the knob is fitted in the groove of the head, and a reception hole is formed to the inside of the knob. The rod is movably located in the passage and has an engaging end formed to the first end thereof. The engaging end is engaged with the reception hole of the knob. A ball is formed to the second end of the rod. The diameter of the ball is smaller than the inner diameter of the passage so that the rod and the ball are movable in the passage. A non-circular hole is formed in the ball.

When the rod is pulled and the ball is rotatably engaged with the two recesses, the rod is pivoted and partially engaged with the groove to rotate the axle.

The present invention also provide another embodiment of a quick-release and comprises an axle that has a head formed to the first end thereof, and an outer threaded end is formed to the second end of the axle. The axle is threadedly connected to a bicycle. A passage is defined axially through the axle. A groove is formed radially through the head. Two recesses are respectively formed in two insides of the groove and located corresponding to the passage. An operation unit includes a knob and a ball. The knob includes a first side and a second side wherein the first side of the knob is fitted in the groove of the head. A rod extends from the first side of the knob to form a T-bar. The rod includes a reception hole formed to the distal end thereof and opposite to the knob. An engaging end extends radially from the ball and is connected to the reception hole. A non-circular hole is formed in the ball. The diameter of the ball is smaller than the inner diameter of the passage so that the rod and the ball are movable in the passage.

When the rod is pulled and the ball is rotatably engaged with the two recesses. The rod is pivoted and partially engaged with the groove to rotate the axle.

The primary object of the present invention is to provide a quick-release wherein the rod is hidden in the axle of the bicycle. The rod is pulled to engage the ball with the recesses so as to quickly rotate the axle.

The present invention includes the following advantages which are that the rod is hidden in the axle, and the operation to rotate the axle by the operation unit is easy and convenient. The head of the axle has the groove and the rod has the ball formed thereto, so that when the rod is pulled, the ball is rotatably engaged with the two recesses in the groove, and the rod is able to be pivoted and engaged with the groove. By pivoting the rod, the axle is rotated so as to be quickly separate the wheel from the chain stay, or to secure the wheel to the chain stay.

The structure of the present invention is simple and the cost for manufacturing the quick-release is low. There is no tiny parts involved in the present invention, the assembly of the quick-release is quick and easy.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the quick-release of the present invention used with the chain stay;

FIG. 2 is a perspective view to show the quick-release of the present invention;

FIG. 3 is an exploded view of the quick-release of the present invention and the chain stay;

FIG. 4 is a cross sectional view of the quick-release of the present invention;

FIG. 5 is an enlarged view the circle 5 in FIG. 4;

FIG. 6 is a cross sectional view to show that the rod is pulled away from the chain stay;

FIG. 7 shows that the rod is pivoted and engaged with the groove of the head of the axle;

FIG. 8 shows that the rod is pivoted to rotate the axle, and

FIG. 9 is an exploded view of another embodiment of the quick-release of the present invention.

### DETAILED DESCRIPTION OF THE PREFERRED EMBODIMENT

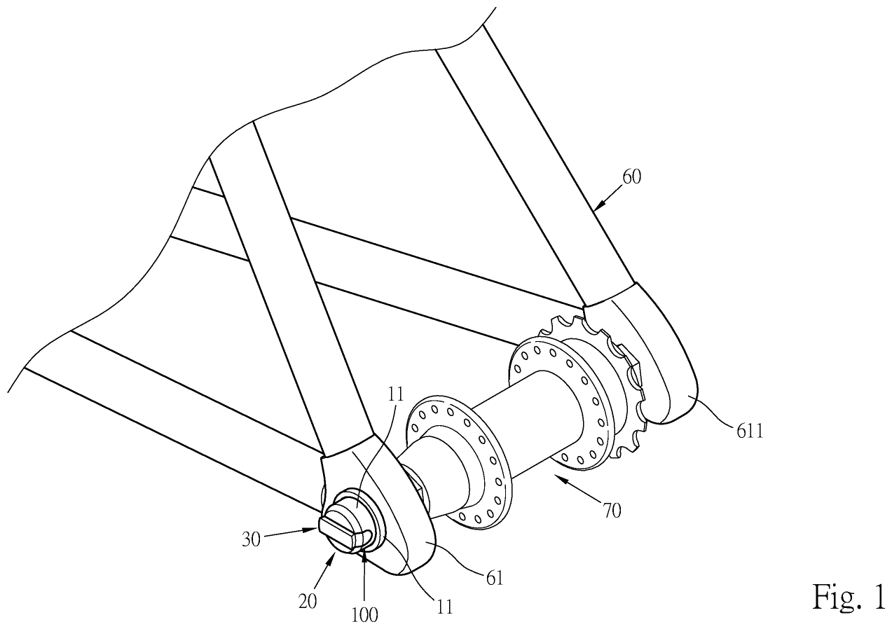

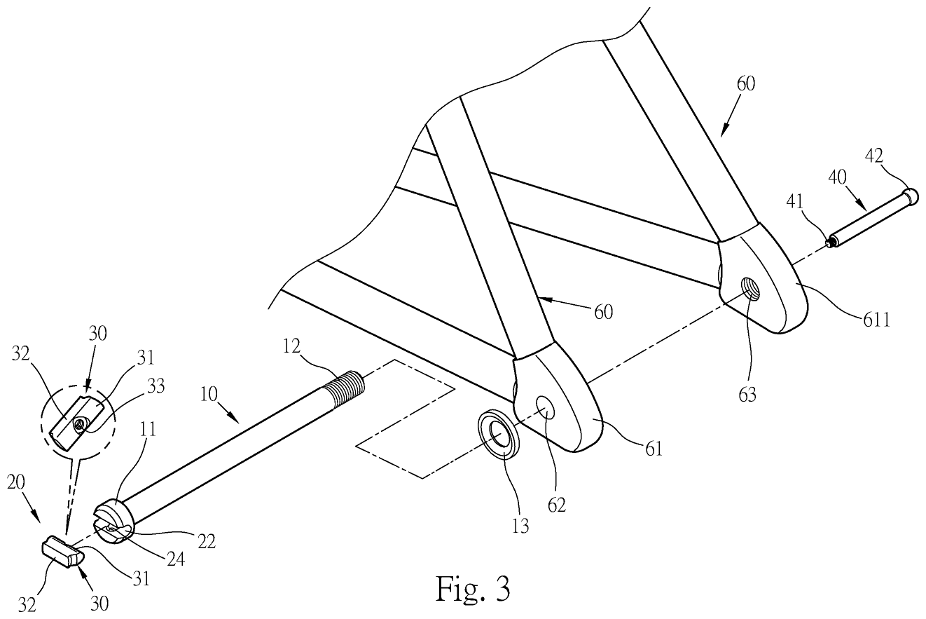

Referring to FIGS. 1 to 3, the chain stay 60 includes two dropouts 61, 611, wherein the dropout 61 includes a through hole 62, and the other dropout 611 includes a threaded hole 63. A rear wheel assembly 70 including a hub is installed between the two dropouts 61, 611. The quick-release 100 of the present invention is used to secure the rear wheel assembly 70 between the chain stay 60.

The quick-release 100 of the present invention comprises an axle 10 and an operation unit 20. The axle 10 has a head 11 formed to the first end thereof, and an outer threaded end 12 is formed to the second end of the axle 10. The axle 10 extends through a washer 13 and the through hole 62, and is threadedly connected to the threaded hole 63 of the chain stay 60 of a bicycle by the outer threaded end 12. A passage 21 is defined axially through the axle 10. A groove 22 is formed radially through the head 11. Two recesses 24 are respectively formed in two insides of the groove 22 and located corresponding to the passage 21. The washer 13 is clamped between the head 11 of the axle 10 and the dropout 61.

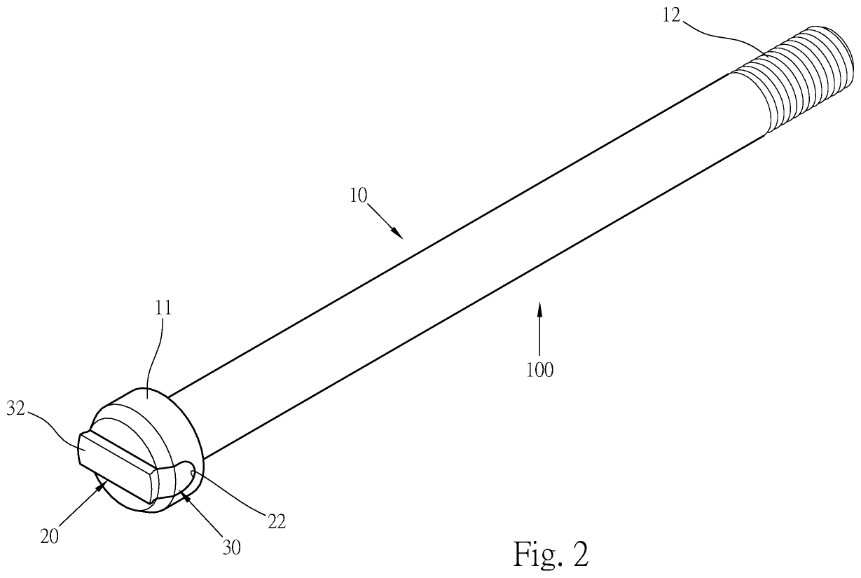

As shown in FIGS. 2 to 4, the operation unit 20 includes a knob 30 and a rod 40. The knob 30 is an elongate knob and includes a first side 31 and a second side 32 which is located opposite to the first side 31. The first side 31 of the knob 30 is fitted in the groove 22 of the head 11. A reception hole 33 is formed to the inside 31 of the knob 30 and located between the two recesses 24 in the groove 22. The reception hole 33 has inner threads formed to an inner periphery thereof. The second side 32 of the knob 30 slightly protrudes beyond the groove 22. Two ends of the knob 30 are in flush with the outer periphery of the head 11.

The rod 40 is movably located in the passage 21, and has an engaging end 41 formed to the first end thereof. The engaging end 41 of the rod 40 includes outer threads which are threadedly connected to the inner threads of the reception hole 33 of the knob 30. A ball 42 is formed to the second end of the rod 40. The diameter of the ball 42 is smaller than the inner diameter of the passage 21 so that the rod 40 and the ball 42 are movable in the passage 21. A non-circular hole 43 is formed in the ball 42, wherein the non-circular hole 43 can be a polygonal hole or a hexagonal hole. A tool may be used to be engaged with the non-circular hole 43 so as to connect the rod 40 to the knob 30.

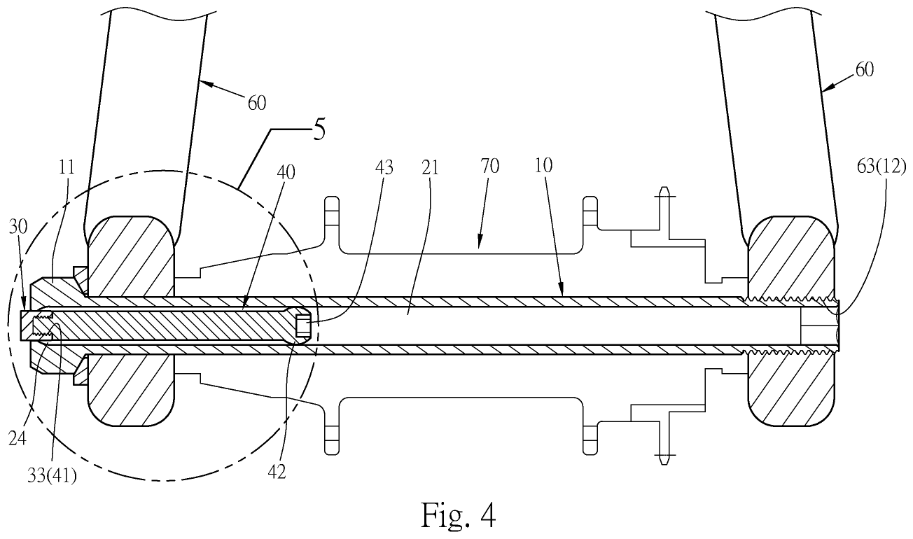

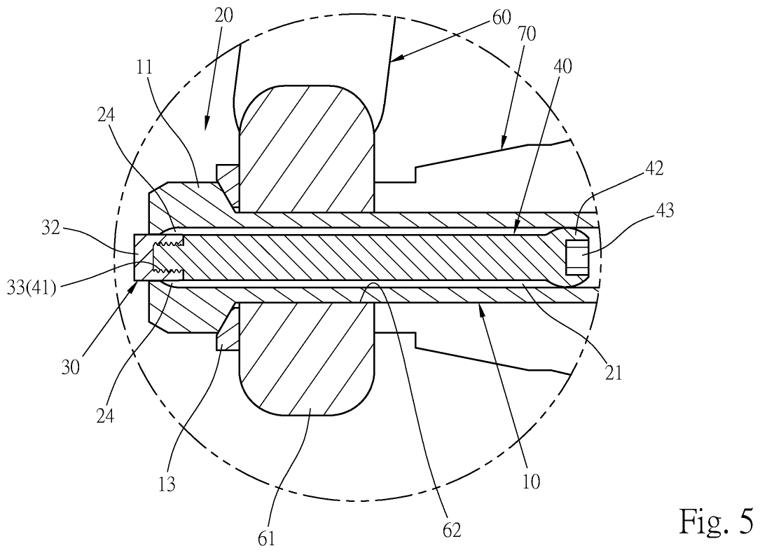

The axle 10 and the rear wheel assembly 70 are installed between the two dropouts 61, 611 of the chain stay 60. The outer threaded end 12 of the axle 10 is connected to the threaded hole 63 of the dropout 611. The engaging end 41 of the rod 40 is inserted into the passage 21 of the axle 10 from the outer threaded end 12 of the axle 10. The first side 31 of the knob 30 is engaged with the groove 22, and a tool is engaged with the non-circular hole 43 so as to connect the engaging end 41 of the rod 40 to the reception hole 33 of the knob 30 as shown in FIGS. 4 and 5. Therefore, the rod 40 is connected to the knob 30, and the rod 40 is hidden in the axle 10. The second side 32 of the knob 30 slightly protrudes beyond the groove 22 as shown in FIG. 1.

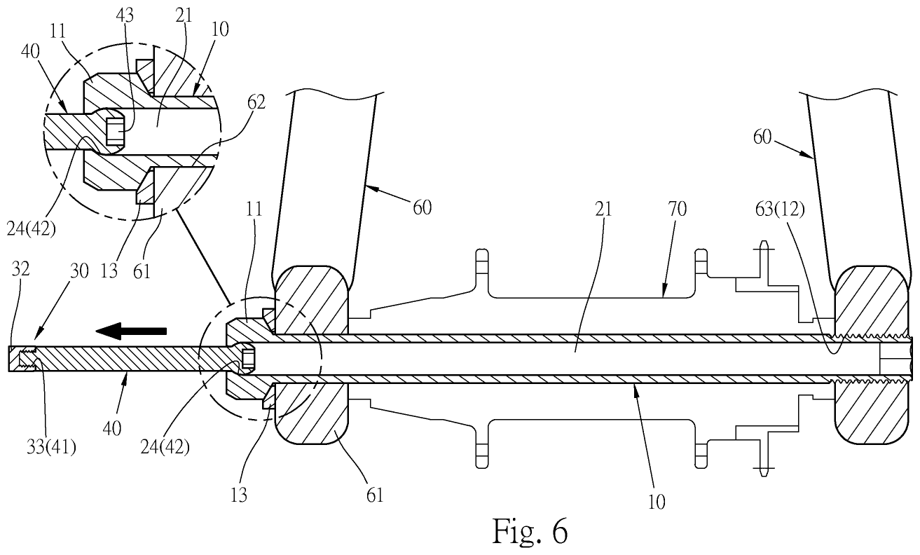

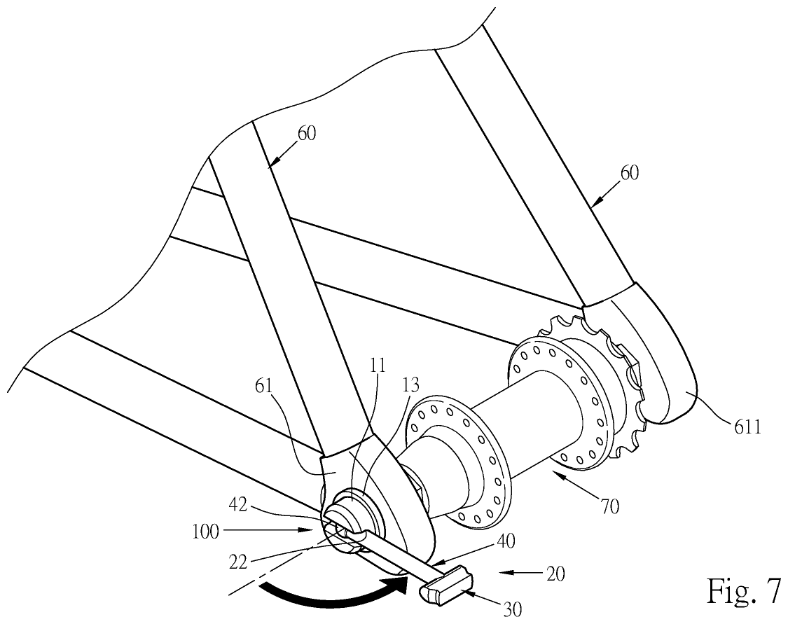

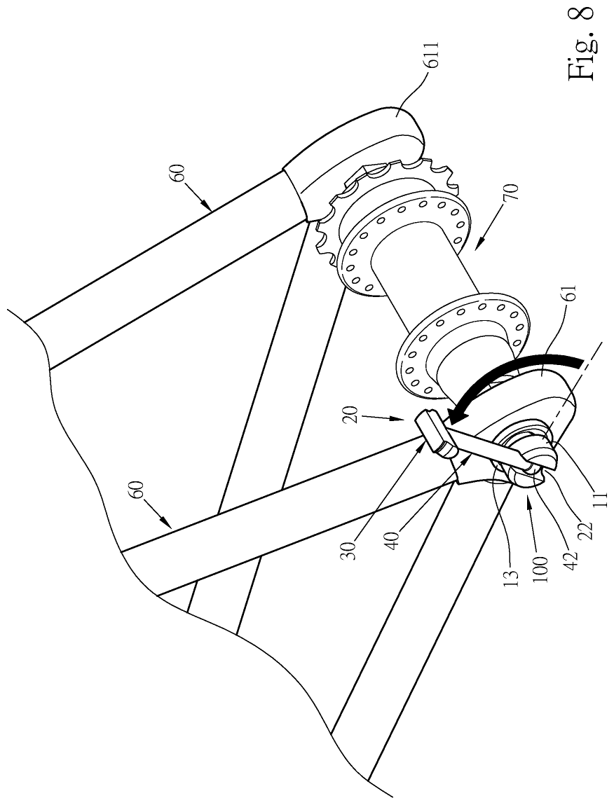

As shown in FIGS. 6 to 8, when in use, the user holds the second side 32 of the knob 30 and pulls the knob 30 away from the head 11 of the axle 10, so that the rod 40 is pulled until the ball 42 is pivotably engaged with the recesses 24, and the rod 40 cannot be completely separated from the axle 10. The rod 40 is then pivoted about 90 degrees to engage the rod 40 with the groove 22. The rod 40 performs as an arm of force and applies a torque to the axle 10 when pivoting the rod 40, such that the axle 10 is rotated and the outer threaded end 12 is disengaged from the threaded hole 63 of the dropout 611. Therefore, the rear wheel assembly 70 can be removed from the chain stay 60.

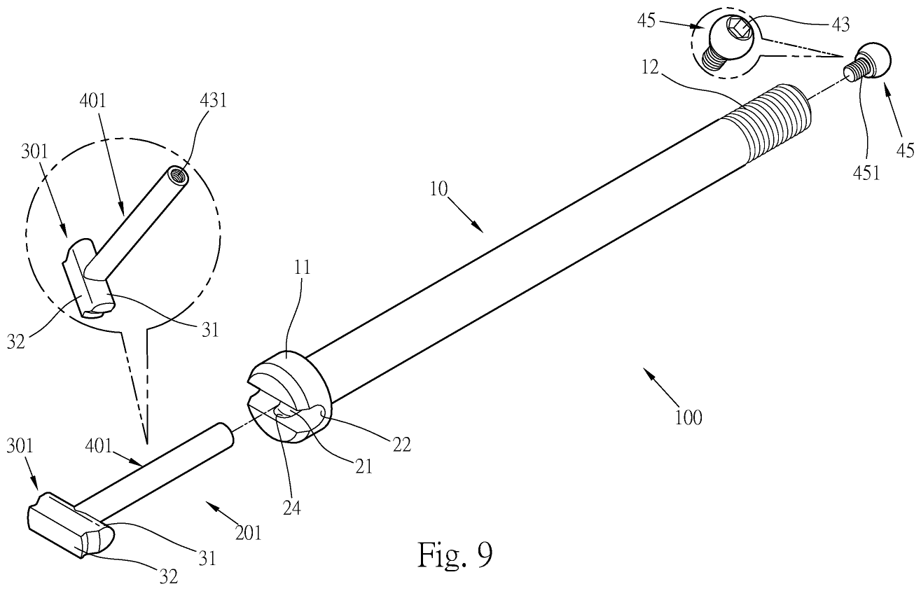

FIG. 9 shows the second embodiment of the quick-release 100 of the present invention comprises an axle 10 having a head 11 formed to the first end thereof, and an outer threaded end 12 is formed to the second end of the axle 10. The axle 10 is threadedly connected between the two dropouts 61, 611. A passage 21 is defined axially through the axle 10. A groove 22 is formed radially through the head 11. Two recesses 24 are respectively formed in two insides of the groove 22 and located corresponding to the passage 21.

An operation unit 201 includes a knob 301 and a ball 45. The knob 301 includes a first side 31 and a second side 32 which is located opposite to the first side 31. The first side 31 of the knob 301 is fitted in the groove 22 of the head 11. A rod 401 extends from the first side 31 of the knob 301 to form a T-bar. The rod 401 includes a reception hole 431 formed to the distal end thereof opposite to the knob 301. An engaging end 451 extends radially from the ball 45 and is connected to the reception hole 431. Specifically, the reception hole 431 has inner threads formed to the inner periphery thereof. The engaging end 451 of the ball 45 includes outer threads which are threadedly connected to the inner threads of the reception hole 431. A non-circular hole 43 is formed in the ball 45. The diameter of the ball 45 is smaller than the inner diameter of the passage 21 so that the rod 401 and the ball 45 are movable in the passage 21.

The rod 401 is inserted into the passage 21 of the axle 10 from the head 11 of the axle 10 until the first side 31 of the knob 301 is engaged with the groove 22. The ball 45 is put into the passage 21 from the threaded end 12 of the axle 10 and a tool (not shown) is engaged with the A non-circular hole 43 so as to threadedly connect the engaging end 451 to the reception hole 431 of the rod 401. When in use, the user holds the second side 32 of the knob 30 and pulls the knob 301 away from the head 11 of the axle 10, so that the rod 401 is pulled until the ball 45 is pivotably engaged with the recesses 24, and the rod 401 cannot be completely separated from the axle 10. The rod 401 is then pivoted about 90 degrees to engage the rod 401 with the groove 22. The rod 401 performs as an arm of force and applies a torque to the axle 10 when pivoting the rod 401, such that the axle 10 is rotated and the outer threaded end 12 is disengaged from the threaded hole 63 of the dropout 611. Therefore, the rear wheel assembly 70 can be removed from the chain stay 60.

While we have shown and described the embodiment in accordance with the present invention, it should be clear to those skilled in the art that further embodiments may be made without departing from the scope of the present invention.

What is claimed is:

1. A quick-release comprising:
an axle having a head formed to a first end thereof, an outer threaded end formed to a second end of the axle, the axle adapted to be threadedly connected to a bicycle, a passage defined axially through the axle, a groove formed radially through the head, two recesses respectively formed in two insides of the groove and located corresponding to the passage, and
an operation unit including a knob and a rod, the knob including a first side and a second side which is located opposite to the first side, the first side of the knob being fitted in the groove of the head, a reception hole formed to the inside of the knob and located between the two recesses in the groove, the rod movably located in the passage, the rod having an engaging end formed to a first end thereof, the engaging end being engaged with the reception hole of the knob, a ball formed to a second end of the rod, a diameter of the ball being smaller than an inner diameter of the passage so that the rod and the ball are movable in the passage, a non-circular hole formed in the ball, when the rod is pulled and the ball is rotatably engaged with the two recesses, the rod is pivoted and partially engaged with the groove to rotate the axle.

2. The quick-release as claimed in claim 1, wherein the reception hole has inner threads formed to an inner periphery thereof, the engaging end of the rod includes outer threads which are threadedly connected to the inner threads of the reception hole.

3. A quick-release comprising:
an axle having a head formed to a first end thereof, an outer threaded end formed to a second end of the axle, the axle adapted to be threadedly connected to a bicycle, a passage defined axially through the axle, a groove formed radially through the head, two recesses respectively formed in two insides of the groove and located corresponding to the passage, and
an operation unit including a knob and a ball, the knob including a first side and a second side which is located opposite to the first side, the first side of the knob being fitted in the groove of the head, a rod extending from the first side of the knob to form a T-bar, the rod including a reception hole formed to a distal end thereof opposite to the knob, an engaging end extending radially from the ball and connected to the reception hole, a non-circular hole formed in the ball, a diameter of the ball being smaller than an inner diameter of the passage so that the rod and the ball are movable in the passage, when the rod is pulled and the ball is rotatably engaged with the two recess, the rod is pivoted and partially engaged with the groove to rotate the axle.

4. The quick-release as claimed in claim 3, wherein the reception hole has inner threads formed to an inner periphery thereof, the engaging end of the ball includes outer threads which are threadedly connected to the inner threads of the reception hole.
